(19) United States
(12) Patent Application Publication
(10) Pub. No.: US 2009/0299821 A1
(43) Pub. Date: Dec. 3, 2009

(54) METHOD AND SYSTEM FOR DETERMINING AND PROVIDING A COMPREHENSIVE PET HEALTH AND NUTRITION FEEDING PLAN

(75) Inventors: Neil Willcocks, Brentwood, TN (US); Christopher Lewis Jones, Brentwood, TN (US)

Correspondence Address: FITZPATRICK CELLA HARPER & SCINTO, 1290 Avenue of the Americas, NEW YORK, NY, 10104-3800, US

(73) Assignee: MARS, INCORPORATED, McLean, VA (US)

(21) Appl. No.: 12/412,938

(22) Filed: Mar. 27, 2009

Related U.S. Application Data
(63) Continuation of application No. 12/097,640, now abandoned.
(60) Provisional application No. 60/751,850, filed on Dec. 20, 2005.

(51) Int. Cl. G06Q 99/00; G06Q 30/00

(52) U.S. Cl. 705/10; 705/14.39; 705/1

(57) ABSTRACT

In order to provide a comprehensive pet health and nutrition feeding plan for a pet, the pet's condition is assessed using a predetermined assessment scheme. A diet suited for the pet's condition is determined using an analysis procedure or algorithm established for the assessment scheme. The assessment scheme takes into account feeding preferences of the pet's owner. A feeding plan is selected according to the determined diet, the feeding preferences, and budget considerations, if any, of the owner. Optionally, the owner may conveniently obtain the combination of foods/treats/supplements/pharmaceuticals in the selected feeding plan at a predetermined location, which is informed of the pet's feeding plan in advance of the arrival of the pet's owner.

### CROSS REFERENCE TO RELATED APPLICATION

This application claims benefit of U.S. Provisional Patent Application No. 60/751,850 filed on Dec. 20, 2005, the entire disclosure of which is incorporated by reference herein in its entirety.

### BACKGROUND OF THE INVENTION

1. Field of the Invention

The present invention relates to a system and a method for determining a recommended feeding plan for a pet and providing a combination of any two or more of: wet and/or dry pet food(s), pet treats, pet supplements, and/or pet pharmaceuticals (“foods/treats/supplements/pharmaceuticals”) according to the feeding plan. The recommended feeding plan is determined based on an assessment of the pet's size, breed type, weight, coat condition, life stage, health, and other characteristics indicative of the general well-being of the pet, as well as an assessment of the lifestyle of the pet and the feeding preferences of the pet's owner.

2. Related Art

Pet owners generally want to provide the best nutrition for their pets, but often are constrained by a limited budget. Therefore, some pet owners may opt to purchase premium foods but forego treats and supplements in order to stay within their budgets. However, for pets that should be receiving supplements to improve their coats, or for pets that have medical conditions that should be treated with pharmaceuticals, for example, this option is not the best course of action for the well-being of the pets.

For pet owners that are not constrained by pet budgets, their pets often are spoiled by an overabundance of high-calorie treats. Therefore, these pets may not be receiving foods, supplements, and/or pharmaceuticals that are particularly suited for their conditions. In other words, despite the best intentions of these pet owners, they may not be the most qualified people to determine the best diets for their pets.

Pet owners may have special feeding relationships with their pets, in which the owners have a preferred feeding schedule that is not well suited for the typical container sizes of pet foods offered today. For example, if an owner prefers to feed her cat five or more times per day to coincide with the times when the owner herself eats, the serving size of a typical can of cat food usually is too large to be given in its entirety to the cat for a single feeding. The owner then must serve only a portion of the can and store the remainder for a later feeding. This arrangement, however, is inconvenient for the owner, who must put up with the odor of an opened can of cat food, either in the refrigerator or on the kitchen counter, for example. This arrangement also can lead to overfeeding of the cat, especially if the owner is overly generous with the feeding portions in order to “finish up” an opened can of cat food.

Many pet owners are uncertain as to the quantity or type of foods (wet and/or dry), treats, supplements, and the like, to give to their pets. As a result of this uncertainty the owners may tend to overfeed their pets or to feed their pets with a type of food that is less than optimal (based on the current conditions of the pets). For example, a sedentary and overweight pet should be receiving low-calorie foods and treats in order to minimize weight gain.

Given the foregoing, a need exists for a convenient way to determine and provide a comprehensive pet health and nutrition feeding plan that takes into account a pet's size, breed type, weight, coat condition, life stage, health, and other characteristics indicative of the current well-being of the pet; health goals for improving the well-being of the pet; the lifestyle of the pet (e.g., active or sedentary, indoor or outdoor, etc.); and feeding preferences of the pet's owner (e.g., natural foods only, wet foods only, only oral-care dry foods, mostly dry foods and little or no wet foods, etc.).

### BRIEF DESCRIPTION OF THE INVENTION

The present invention meets the above-identified need by providing a method and a system for: assessing a pet's condition using a predetermined assessment scheme; determining feeding preferences of the pet's owner; determining a feeding plan suited for the pet's condition using an analysis procedure or algorithm established for the assessment scheme, which takes into consideration the owner's feeding preferences; selecting a bundled combination according to the determined feeding plan and, optionally, budget considerations of the owner, if any. The bundled combination includes, for example, any two or more of: pet food(s) (wet and/or dry), pet treats, pet supplements (e.g., vitamins and/or herbal products, etc.), and pharmaceuticals. The items in the bundled combination are determined to be best suited for the pet's well-being based on a result of the assessment and based on the feeding preferences and, optionally, any budget considerations the owner may have.

According to an aspect of the invention, an assessment is made of a current condition of the pet, and a recommended diet is determined based on the assessment. The pet's owner enrolls the pet in a desired feeding plan based on the recommended diet and the owner's pet-maintenance budget. Preferably, the pet's owner enrolls in the feeding plan through a merchant, such as a supermarket for pet-related products or a veterinarian, for example. The owner then obtains the plan's foods/treats/supplements/pharmaceuticals at a convenient predetermined location, such as the merchant's store or the veterinarian's office, for example. Each plan provides, on a periodic basis (e.g., bi-weekly, monthly, etc.), sufficient foods/treats/supplements/pharmaceuticals for the period. The types of foods/treats/supplements/pharmaceuticals provided depends on the results of the assessment for the pet (i.e., the recommended diet). Therefore, if the pet is assessed to have a dull coat, then suitable vitamins and/or other types of supplements may be included in the plan; if the pet is advanced in age, then the plan's food may be food for senior pets; or if the pet has a medical condition, then prescribed pharmaceuticals may be included in the plan.

According to another aspect of the invention, the assessment is performed based on a computerized survey, in which a veterinarian uses a computer to input answers to the survey. Optionally, instead of a veterinarian, a person trained to understand the survey and the process of assessing a pet's condition may perform the assessment. For example, the trained person may be a consultant or an associate (“consultant/associate”) located at the merchant's store or at the veterinarian's office. The survey answers automatically are analyzed according to an algorithm designed to assess the health and well-being of the pet being assessed. The computer then outputs the recommended diet for the pet. Optionally, instead of outputting the recommended diet, the computer may output suggestions for various diets, which the veterinarian or the consultant/associate then discusses with the pet's owner.

According to another aspect of the invention, the assessment is performed manually by the veterinarian, and the veterinarian uses a “recommended-diet notepad” similar to a physician's prescription pad to note the pet's recommended diet and to direct the pet's owner to the merchant's store to determine the desired feeding plan. The notepad may include pre-printed information about the different feeding plans available as well as information about incentives for enrolling in a plan.

According to another aspect of the invention, the assessment is performed by the pet's owner according to a predetermined computerized survey, in which the owner uses a programmed computer to input answers to the survey via an interactive program. That is, involvement by a veterinarian or a consultant/associate is not necessary. The answers inputted by the owner automatically are analyzed according to an algorithm designed to assess the health and well-being of the pet. The computer then outputs the recommended diet for the pet.

According to another aspect of the embodiment, a kiosk or a booth (“kiosk/booth”) at the merchant's store or at the veterinarian's office may be used by the pet's owner to complete the survey to determine the recommended diet for the pet. This way, the owner conveniently may determine the recommended diet, decide on a desired feeding plan, and purchase foods/treats/supplements/pharmaceuticals for the feeding plan all at the same location. Preferably, the kiosk/booth is equipped with a computer or other type of communication device for accessing a server that controls an interactive assessment program for a plurality of kiosks/booths. Optionally, instead of accessing a server, the computer may have the interactive assessment program stored therein.

According to still another embodiment of the invention, assessments of the pet are made over a period of time to determine the efficacy of the recommended diet in maintaining or improving the pet's condition. The assessments are stored in a database and used to refine the program's algorithm for determining future recommended diets.

### BRIEF DESCRIPTION OF THE DRAWING

The features and advantages of the present invention will become more apparent from the detailed description set forth below when considered in conjunction with the attached drawing.

FIG. 1 schematically illustrates a system diagram of an exemplary assessment system used to implement an embodiment of the present invention.

### DETAILED DESCRIPTION OF THE INVENTION

The present invention is directed to a method and a system for: assessing a pet's condition using a predetermined assessment scheme; determining feeding preferences of the pet's owner; determining a feeding plan suited for the pet's condition using an analysis procedure or algorithm established for the assessment scheme, which takes into consideration the owner's feeding preferences; enabling the selection of a bundled combination by the owner. The bundled combination includes, for example any two or more of: pet food(s) (wet and/or dry), pet treats, pet supplements (i.e., vitamins and/or herbal products, etc.), and pharmaceuticals. Items in the bundled combination are those determined to be best suited for the pet's well-being based on a result of the assessment and based on the feeding preferences of the owner. Optionally, selection of the bundled combination takes into account budget considerations, if any, of the owner.

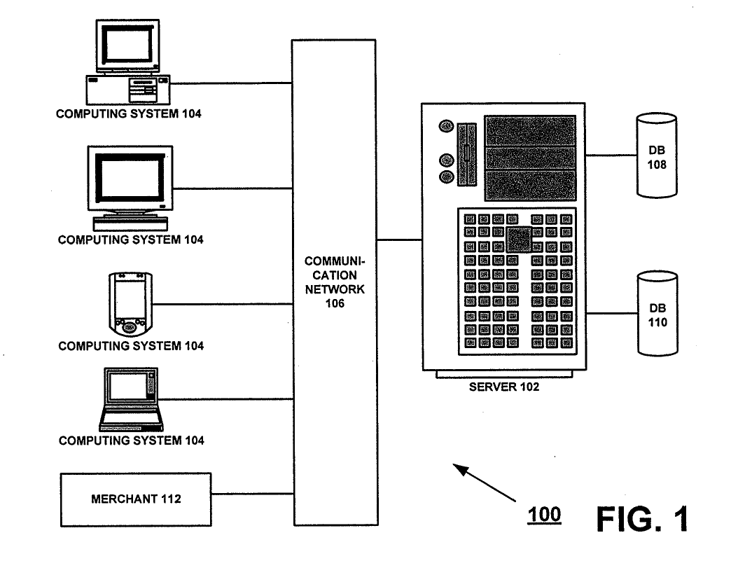

FIG. 1 shows a schematic system diagram of an exemplary assessment system 100, used to implement or practice one or more embodiments of the present invention. System 100 includes a server 102 interconnected with one or more computing systems 104 via a communication network 106. Server 102 has access to a plurality of databases in/from which information is stored/retrieved, such as an assessment-results database 108, which identifies each pet for which an assessment has been performed and stores the assessment results for the pets, and a recommended-diets database 110, which stores a plurality of diet plans each corresponding to an assessment result, for example. Communication network 106 may be the Internet, a public switched telephone network (PSTN), or any other means of communication between server 102 and computing system(s) 104, whether wired or wireless. Computing system 104 may be used by a veterinarian or a trained assessment consultant/associate to communicate with server 102, and may be a personal computer, a workstation, a mainframe computer, a kiosk, a personal digital assistant, or any other digital device able to perform data communication with server 102. Server 102 is programmed to provide an interactive assessment survey to computing system 104, to analyze inputted survey answers, and to provide recommendations according to analysis results.

The assessment survey may be downloaded from server 102 to computing system 104, such that the assessment survey is resident on a hard drive of computing system 104. Optionally, the assessment survey may be loaded in a memory of computing system 104 via a computer-readable storage medium (e.g., a DVD, a CD, etc.) without the need to access server 102.

The assessment survey enables a current condition of the pet to be assessed, based on answers provided to queries in the survey. Additionally, the survey obtains information on feeding preferences of the pet's owner, including preferred: frequency of feedings (e.g., once daily; five-times per day; wet food twice daily and dry food once daily; etc.), type(s) of food (e.g., wet food, dry food, only natural food(s), a combination of natural and regular foods, etc.), use of particular products for treats (e.g., use of oral-care dry food as treats, etc.), for example. The term “natural,” as used herein, generally refers to foods that have by-product specifications established by the AAFCO, as will be appreciated by persons skilled in the art. A recommended diet is determined based on the assessment. (As used herein, the term “diet” includes any combination of foods (wet and/or dry), treats, supplements, and pharmaceuticals). The pet's owner enrolls the pet in a desired feeding plan based on the recommended diet and, optionally, the owner's pet-maintenance budget. For example, for a modest-budget feeding plan (e.g., a “Bronze Plan”), the recommended diet includes a combination of standard foods/treats/supplements/pharmaceuticals chosen to maintain or improve the pet's condition; for a high-budget feeding plan (e.g., a “Platinum Plan”), the recommended diet includes premium foods/treats/supplements/pharmaceuticals chosen to maintain or improve the pet's condition. As will be appreciated by persons of skill in the art, feeding plans for other budget levels also may be available and within the scope of the present invention (e.g., a “Gold Plan,” a “Silver Plan,” etc.).

As used herein, the term “foods/treats/supplements/pharmaceuticals” is intended to indicate any combination of two or more of the four categories of feeding-plan products (i.e., foods (wet and/or dry) and treats; foods, treats, and pharmaceuticals; foods, treats, and supplements; etc.); the combination is not required to include all four categories of products. Preferably, the combination includes food (wet and/or dry) and at least one other category of feeding-plan products.

The pet's owner enrolls in the feeding plan through a merchant 112, such as a supermarket for pet-related products. The owner then obtains the plan's foods/treats/supplements/pharmaceuticals at a convenient predetermined location, such as the merchant's store. The owner is given an incentive by merchant 112 to enroll in the plan and to make repeat purchases of the plan's foods/treats/supplements/pharmaceuticals from the merchant's store. For example, the incentive may be that the total cost to the owner of the food/treats/supplements if purchased as a bundle under the plan would be less than the cumulative cost to the owner of the food/treats/supplements/pharmaceuticals if purchased separately (e.g., the fixed cost for a purchase under the plan gives the owner a discount of 30%, for example, for the combined purchase of the foods/treats/supplements/pharmaceuticals); or the incentive may be a discount card that enables every fifth bundled purchase under the plan to receive a discount of, for example, 50%. In another example, the incentive may be to provide the owner with a gift for signing on to purchase periodic bundles for a term of, for example, one year. Other types of loyalty incentives are also contemplated.

As will be appreciated by persons of skill in the art, and as discussed above, pharmaceuticals need not be included in the plan, especially if merchant 112 is not licensed to dispense pharmaceuticals. However, if the plan is purchased from a veterinarian who is licensed to dispense pharmaceuticals, then the plan may include pharmaceuticals.

Each plan provides, on a periodic basis (e.g., bi-weekly, monthly, etc.), sufficient foods/treats/supplements/pharmaceuticals for the period. For example, a monthly Bronze Plan for a cat may provide a month's supply of standard dry and/or wet cat food, a container of about 60 standard treats (suitable for about 2 treats per day), a month's supply of standard vitamins and/or other types of supplements, and if necessary a month's supply of generic pharmaceuticals for treating a heart condition. Similarly, for a monthly Platinum Plan, a month's supply of premium dry and/or wet cat food, a month's supply of premium treats, a month's supply of premium supplements, and a month's supply of name-brand pharmaceuticals may be included in the plan. The types of foods/treats/supplements/pharmaceuticals provided depends on the results of the assessment for the cat (i.e., the recommended diet, which takes into account the feeding preferences of the pet's owner). Therefore, if the cat is assessed to have a dull coat, then suitable vitamins and/or other types of supplements may be included in the plan; if the cat is advanced in age, then the plan's food may be food for senior cats; if the owner prefers only natural foods, then the plan may include only natural foods; if the owner prefers natural and/or indulgent foods, then the plan may include one or both of natural foods and indulgent foods; and if the cat requires pharmaceuticals, then the plan may include suitable pharmaceuticals.

If the assessment determines that the feeding preferences of the pet's owner is to feed the pet small quantities of wet food several times (e.g., five or more times) per day, then the feeding plan may include small single-serving wet-food pouches that avoids the need for the owner to store opened cans of partially used food. This feature removes the uncertainty the owner may have about the appropriate amount of food to feed the pet, especially when the pet is fed several times per day, and also removes the uncertainty of whether the proper food is being given to the pet. As a consequence, the feeding plan enhances the owner's feeding experience by removing anxiety and guilt from the feeding experience.

According to an embodiment of the invention, the assessment is performed based on a computerized survey, in which a veterinarian uses a computer to input answers to the survey. The answers automatically are analyzed according to an algorithm designed to assess the health and well-being of the pet under observation. The computer then outputs the recommended diet for the pet. Optionally, instead of a veterinarian, a person trained to understand the survey and the process of assessing a pet's condition may perform the assessment, such as a consultant/associate located at the merchant's store or at the veterinarian's office.

The computerized assessment survey may be in the form of an interactive program stored locally in a memory unit of computing system 104 and executed by a microprocessor of computing system 104. That is, the program may be locally installed in a computer used by the veterinarian or the consultant/associate without requiring that the computer be in communication with server 102. This allows the veterinarian or the consultant/associate to perform “mobile” pet assessments using, for example, a laptop at any desired location (e.g., a shopping mall), which may not provide an easy way for the laptop to connect to a communication network. If desired, results from such mobile assessments may later be uploaded to server 102 so that they may be stored in database 108. As will be appreciated by persons of skill in the art, when the program is locally installed in computers used by veterinarians or consultants/associates, a plurality of diet plans each corresponding to an assessment result is stored locally in the computers in association with the locally-installed program.

Alternatively, as mentioned above, the interactive program may be stored off-site in a memory unit accessible by server 102 and shared (accessible) by other computing systems 104, and is accessible by each computing system 104 through communication network 106. The program provides an electronic user interface that queries the veterinarian or the consultant/associate to provide responses to survey questions about the pet being examined. Once the responses have been entered, via computing system 104, the program uses the responses in an algorithm to determine the recommended diet or to provide suggestions for various diets, which are discussed with the pet's owner before a plan is chosen.

Preferably, the veterinarian or the consultant/associate encourages the pet's owner to enroll the pet in a feeding plan by informing the owner of the benefits to the pet of a combined regimen of the plan's foods/treats/supplements/pharmaceuticals, and by informing the owner of the savings the owner would be entitled to if the plan's foods/treats/supplements/pharmaceuticals are purchased together in a bundle from merchant 112 than if purchase separately. According to one option, computing system 104 transmits information on the pet and the pet's recommended diet to a computer at the merchant's store for the convenience of the pet's owner. Then, when the owner goes to the merchant's store, a feeding-plan consultant discusses various feeding-plan options (e.g., Bronze Plan, Platinum Plan, etc.) with the owner and determines the desired feeding plan for the pet. The owner then purchases the plan's foods/treats/supplements/pharmaceuticals on a periodic basis or as needed from the merchant's store. According to another option, computing system 104 transmits information on the pet, the pet's recommended diet, and the desired feeding plan to a computer at the merchant's store for the convenience of the pet's owner. Then, the owner can purchase the plan's foods/treats/supplements/pharmaceuticals on a periodic basis or as needed from the merchant's store.

According to another embodiment of the invention, the assessment is performed manually and the veterinarian uses a “recommended-diet notepad” similar to a physician's prescription pad to note the pet's recommended diet and to direct the pet's owner to the merchant's store to determine the desired feeding plan. The notepad may include pre-printed information about the different feeding plans available as well as information about incentives for enrolling in a plan, as discussed above.

According to yet another embodiment of the invention, various aspects of the computerized survey and the manual assessment may be combined.

According to a further embodiment of the invention, the assessment is performed by the pet's owner according to a predetermined computerized assessment survey, in which the owner uses computing system 104 to input answers to the survey. That is, involvement by a veterinarian or a consultant/associate is not necessary. The answers inputted by the owner automatically are analyzed according to an algorithm designed to assess the health and well-being of the pet being assessed. The computer then outputs the recommended diet for the pet.

The assessment survey may be in the form of an interactive program stored in a memory unit accessible by server 102 and shared (accessible) by pet owners, veterinarians, pet caretakers, and the like, through computing systems 104 communicating over communication network 106. The program provides an electronic user interface that queries the pet owner to provide responses to survey questions about the pet being assessed. Once the responses have been entered, the program uses the responses in an algorithm to determine the recommended diet.

Preferably, the program presents the pet's owner with information encouraging enrollment of the pet in a feeding plan offered by the merchant by informing the owner of the benefits to the pet of a combined regimen of the plan's foods/treats/supplements/pharmaceuticals, and by informing the owner of the savings the owner would be entitled to if the plan's food/treats/supplements are purchased together from merchant 112 than if purchase separately. Then, when the owner goes to the merchant's store, a feeding-plan consultant discusses various feeding-plan options (e.g., Bronze Plan, Platinum Plan, etc.) with the owner and determines the desired feeding plan for the pet. The owner then purchases the plan's foods/treats/supplements on a periodic basis or as needed, as discussed above.

According to an aspect of the embodiment, a kiosk/booth at the merchant's store or at the veterinarian's office may be used by the pet's owner to complete the survey to determine the recommended diet for the pet. This way, the owner conveniently may determine the recommended diet, decide on a desired feeding plan, and purchase foods/treats/supplements/pharmaceuticals for the feeding plan all at the same location. Preferably, the kiosk/booth is equipped with a computer or other type of communication device (e.g., computing system 104) for accessing server 102, which controls an interactive assessment program for a plurality of kiosks/booths.

According to still another embodiment of the invention, assessments of the pet are made over a period of time to determine the efficacy of the recommended diet in maintaining or improving the pet's condition. The assessments are stored in database 110 and used to refine the program's algorithm for determining future recommended diets.

The various embodiments of the present invention described above have been presented by way of example and not limitation. It will be apparent to persons skilled in the relevant arts that various changes in form and detail can be made therein without departing from the spirit and scope of the present invention. Thus, the present invention should not be limited by any of the above-described exemplary embodiments, but should be defined only in accordance with the following claims and their equivalents. It is also to be understood that the steps and processes recited in the claims need not be performed in the order presented.

In addition, it should be understood that the attached drawing, which highlights the functionality and advantages of the present invention, are presented as an illustrative example. The system arrangement of the present invention is sufficiently flexible and configurable, such that it may be utilized and configured in ways other than that shown in the drawing.

1. A method for determining and providing a pet feeding plan, the method comprising the steps of:
performing an assessment of a current condition of a pet;
determining feeding preferences of an owner of the pet;
using a computer to determine a recommended diet for the pet based on the assessment, a pet-diet algorithm, and the feeding preferences of the owner;
based on the recommended diet, determining a desired feeding plan; and
providing a bundled combination of any two or more of: food, treats, supplements, and pharmaceuticals at a predetermined location, wherein the combination corresponds to the desired feeding plan,
wherein the food is wet food, dry food, or a combination of both wet food and dry food, and
wherein the current condition of the pet includes a current lifestyle of the pet.

2. The method of claim 1, wherein the feeding preferences include any one or more of: feeding frequency, type of food, type of treat, forbidden foods, and portion size per feeding.

3. The method of claim 1, wherein the combination is provided at a total cost to a purchaser that is less than a cumulative cost to the purchaser of items of the combination purchased separately.

4. The method of claim 1, further comprising the step of determining a desired budget level of the owner, wherein the desired feeding plan is determined based on the desired budget level.

5. The method of claim 1, wherein the desired feeding plan is selected from a plurality of tiered levels.

6. The method of claim 5, wherein, within each of the plurality of tiered levels, at least one bundled combination is offered having items that correspond to the feeding preferences of the owner.

7. The method of claim 5, wherein the plurality of tiered levels includes a plurality of budget levels.

8. (canceled)

9. The method of claim 5, wherein the plurality of tiered levels includes a plurality of food-type levels.

10. The method of claim 9, wherein the plurality of food-type levels includes a natural-food level, an indulgent-food level, and a regular food level.

11. (canceled)

12. The method of claim 1, wherein the assessment takes into consideration any combination of: size, breed type, weight, life stage, sex, coat condition, lifestyle, and health of the pet.

13. The method of claim 1, wherein the assessment is performed using a computerized survey completed by a veterinarian, by a trained consultant, or by a pet owner.

14. The method of claim 13, wherein the computerized survey is obtained from a computer-readable storage medium or a server accessible via the Internet.

15. (canceled)

16. The method of claim 1, wherein the method is performed at a merchant's store or at a veterinarian's office.

17. The method of claim 1, further comprising the steps of:
performing a plurality of assessments of the pet over a period of time during which the pet is on the desired feeding plan; and
refining the pet-diet algorithm based on the plurality of assessments.

18. The method of claim 1, further comprising the step of updating the pet-diet algorithm according to information obtained from users of the pet-diet algorithm.

19. (canceled)

20. A method for reducing uncertainty about feeding a pet, the method comprising the steps of:
performing an assessment of a current condition of a pet;
determining feeding preferences of an owner of the pet;
using a computer to determine a recommended feeding plan for the pet based on the assessment, a pet-diet algorithm, and the feeding preferences of the owner;
based on the recommended feeding plan, enabling the owner to select from a plurality of feeding bundles; and
providing a selected feeding bundle that includes any two or more of: food, treats, supplements, and pharmaceuticals,
wherein the food is wet food, dry food, or a combination of both wet food and dry food,
wherein the current condition of the pet includes a current lifestyle of the pet, and
wherein the feeding preferences of the owner include a preferred frequency of feedings.

21. The method of claim 20,
wherein the plurality of feeding bundles includes feeding bundles of assorted flavors.

22-25. (canceled)

26. A computer-based system for determining a pet feeding plan, comprising:
a memory storing an interactive pet well-being survey program, the program including a pet assessment algorithm; and
a server connected to a communication network, the server being configured to:
provide an interactive user interface to a user computer via the network, wherein the user interface prompts a user to provide responses to queries regarding a pet,
receive the responses from the user computer via the network,
use the algorithm to process the responses to determine a recommended diet for the pet,
notify the user of the recommended diet,
based on the recommended diet, inform the user of a plurality of feeding plans of different tiered levels offered by a merchant and an incentive for selecting and enrolling in a feeding plan,
wherein each feeding plan includes a combination of any two or more of: food, treats, supplements, and pharmaceuticals, and
wherein each feeding plan is provided at a total cost to a consumer that is less than a cumulative cost to the consumer of items of the feeding plan purchased separately.

27-39. (canceled)
